(19) United States
(12) Patent Application Publication
(10) Pub. No.: US 2026/0225609 A1
(43) Pub. Date: Aug. 6, 2026

(54) Preventing Traversal of Unsensed Areas for an Autonomous Work Vehicle

(71) Applicant: Autonomous Solutions, Inc., Mendon, UT (US)

(72) Inventor: Taylor Bybee, Mendon, UT (US)

(73) Assignee: Autonomous Solutions, Inc., Mendon, UT (US)

(21) Appl. No.: 19/266,144

(22) Filed: Jul. 10, 2025

Related U.S. Application Data
(60) Provisional application No. 63/753,942, filed on Feb. 5, 2025.

(51) Int. Cl. B60W 60/00; B60W 10/18; B60W 10/20

(52) U.S. Cl. CPC B60W 60/001; B60W 10/18; B60W 10/20; B60W 2554/00; B60W 2555/00; B60W 2710/18; B60W 2710/20

(57) ABSTRACT

Disclosed are systems and methods for operating an autonomous vehicle. Specifically, disclosed are systems and methods for updating the occlusion probability associated with a plurality of cells within an occlusion probability map generated by the sensor field of view. The method comprises propagating a previous occlusion probability associated with a cell to the current occlusion probability, even if non-occluded sensor data is not available, if an elapsed time between attempted observation of the cell and successful observation of the cell is within a time threshold. The method may enable the autonomous vehicle to continue at operational efficiency despite occlusion of the one or more sensors used to navigate the vehicle.

### BACKGROUND

For safe navigation through an environment, autonomous ground vehicles rely on sensory inputs such as cameras, LiDAR, and radar for detection and classification of obstacles and impassable terrain. These sensors provide data representing 3D space surrounding the vehicle. Often this data is obscured by dust, precipitation, objects, or terrain, producing gaps in the sensor field of view. These gaps, or occlusions, can indicate the presence of obstacles, negative obstacles, or rough terrain. Because sensors receive no data in these occlusions, sensor data provides no explicit information about what might be found in the occluded areas.

### SUMMARY

Disclosed are autonomous vehicles, autonomous vehicle systems, and methods of navigating an autonomous vehicle. The autonomous vehicle may be navigated by continuing to rely on non-occluded sensor data, despite more recent reception of occluded sensor data, when the non-occluded sensor data was received within a time threshold. In this manner, operation delays caused by momentary reduced perception of the sensor view (e.g., due to dust, rain, or other environmental conditions) may be minimized and/or reduced, particularly when non-occluded sensor data is relatively recent and most reliable. This may enable an autonomous vehicle to operate with increased efficiency, reducing operational delays, and diminishing repeated vehicular stops due to intermittent sensor view loss.

An exemplary autonomous vehicle may comprise a steering control system, a speed control system, one or more sensors, and one or more processors communicatively coupled with the one or more sensors, the steering control system, and the speed control system. The autonomous vehicle may also comprise one or more computer-readable media having stored thereon instructions that when executed by the one or more processors navigate the autonomous vehicle within the operating environment. Navigation of the autonomous vehicle may comprise, at a first time, receiving observed sensor data from a sensor of the one or more sensors showing that a subset of cells of a plurality of cells within an occlusion probability map has been observed, wherein the occlusion probability map represents a sensor field of view within an operating environment. At a second time, occluded sensor data may be received from the sensor of the one or more sensors showing at least the subset of cells of the plurality of cells has not been observed. Thereafter, the steering control system and the speed control system may be instructed to drive the autonomous vehicle along a path through an area in the operating environment associated with the occluded sensor data when an elapsed time between the first time and the second time is below a time threshold.

The observed sensor data may show that the subset of cells of the plurality of cells within the occlusion probability map is non-occluded. The one or more processors may further execute instructions that set an occlusion probability of the subset of cells within the plurality of cells of the occlusion probability map to a value associated with an observed state based on the observed sensor data, and, after occluded sensor data is received, set the occlusion probability of the subset of cells to a value associated with an Unknown, Occluded, or Likely Occluded state when the elapsed time (i.e., the time between the first time when observed sensor data is received and the second time when occluded sensor data is received) is equal to or greater than the time threshold.

The one or more sensors includes a camera, and the one or more processors further execute instructions that send a camera image from the camera and associated with a sensor field of view of the sensor to a remote operator, and receive an indication associated with the remote operator indicating whether an obstacle is present within the camera image. When the indication from the remote operator indicates presence of an obstacle within the sensor field of view the one or more processors can set an occlusion probability of the subset of cells to a different value. The occlusion probability of the subset of cells of the plurality of cells may be initialized to a value corresponding to an Unknown state, an Occluded state, or a Likely Occluded state. The one or more sensors may comprise a LiDAR and may additionally, or alternatively, comprise a depth camera, structured light camera, or a stereo camera.

Also disclosed is a method for navigating an autonomous vehicle. The method may comprise, at a first time, receiving observed sensor data from a sensor of one or more sensors showing that a subset of cells of a plurality of cells within an occlusion probability map has been observed. The method may further comprise, at a second time, receiving occluded sensor data from the sensor of the one or more sensors showing at least the subset of cells of the plurality of cells has not been observed and instructing a steering control system and a speed control system of an autonomous vehicle to drive the autonomous vehicle along a path through an area in an environment associated with the occluded sensor data when an elapsed time between the first time and the second time is below a time threshold.

The method may further comprise sending a camera image associated with a sensor field of view of the sensor to a remote operator. The method may comprise receiving an indication associated with the remote operator indicating whether an obstacle is present within the camera image. The occlusion probability of the subset of cells may be initialized to an initial value corresponding to an Unknown state, an Occluded state, or a Likely Occluded state. The occlusion probability of the subset of cells may be set to a subsequent value different from the initial value in response to receiving an indication associated with a remote operator.

The method may include determining whether a cell of the subset of cells is independent when the cell has not been observed, setting an occlusion probability of the cell to a previous occlusion probability when the cell is not independent, and setting the occlusion probability using an occlusion probability update function when the cell is independent. Additionally, or alternatively, the method may comprise determining whether a cell of the subset of cells is independent when the elapsed time is equal to or greater than the time threshold, setting an occlusion probability of the cell to a previous occlusion probability when the cell is not independent, and setting the occlusion probability using an occlusion probability update function when the cell is independent.

The occlusion probability update function may comprise

$${m}_{r , c}^{k} = 1 - ( 1 - {s}_{r , c} ) ( 1 - {m}_{r , c}^{k - 1} ) ,$$

where

$${m}_{r , c}^{k}$$

represents the occlusion probability of map m of the cell at column c and row r for iteration k and s_{r,c} represents a scan cell detection probability of the cell at column c and row r. comprises

$${m}_{r , c}^{k} = 1 - ( 1 - {s}_{r , c} ) ( 1 - {m}_{r , c}^{k - 1} ) ,$$

where

$${m}_{r , c}^{k}$$

represents the occlusion probability of map m of the cell at column c and row r for iteration k and s_{r,c} represents a scan cell detection probability of the cell at column c and row r. The occlusion probability update function may comprise a sequence of Bernoulli random variables or a binary Bayes filter.

Also disclosed is a vehicle platform comprising a steering control system and a speed control system, one or more sensors coupled with the vehicle platform, and a processor communicatively coupled with the one or more sensors, wherein the processor executes the above method. The vehicle platform may include a steering mechanism in communication with the processor, and the processor may communicate steering commands to the steering mechanism based on an occlusion probability of the subset of cells. Additionally, or alternatively, the vehicle platform may comprise a braking mechanism in communication with the processor, and the processor may communicate braking commands to the braking mechanism based on an occlusion probability of the subset of cells. The one or more sensors of the vehicle platform may comprise a depth camera, structured light camera, or a stereo camera.

Also disclosed is an autonomous vehicle comprising a steering control system, a speed control system, one or more sensors, and one or more processors communicatively coupled with the one or more sensors, the steering control system, and the speed control system. The autonomous vehicle may also comprise one or more computer-readable media having stored thereon instructions that may be executed by the one or more processors. The instructions may include, at a first time, receiving observed sensor data from a sensor of the one or more sensors showing that a subset of cells of a plurality of cells has been observed and instructing the steering control system and the speed control system to drive the autonomous vehicle along a path through an area in environment associated with the observed sensor data.

The instructions may also include, at a second time when an elapsed time between the first time and the second time is less than a time threshold, receiving first occluded sensor data from the sensor of the one or more sensors showing that the subset of cells has not been observed, and instructing the steering control system and the speed control system to drive the autonomous vehicle along a path through an area in environment associated with the first occluded sensor data. The instructions may comprise, at a third time when an elapsed time between the first time and the third time is equal to or greater than the time threshold, receiving second occluded sensor data from the sensor of the one or more sensors showing that the subset of cells has not been observed, and instruct the steering control system and the speed control system to stop the autonomous vehicle from driving along a path through an area in the operating environment associated with the second occluded sensor data.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

The patent or application file contains at least one drawing executed in color. Copies of this patent or patent application publication with color drawing(s) will be provided by the Office upon request and payment of the necessary fee.

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIG. 1 is a flowchart of an example process for updating a cell according to some embodiments.

FIG. 2 is a flowchart of an example process for updating a cell according to some embodiments.

FIG. 3 is a flowchart of an example process for updating a cell according to some embodiments.

FIG. 4 is a diagram of an occlusion state transition model for each cell according to some embodiments.

FIG. 5A is an example simulated scan probability for a sensor field of view grid G using some embodiments described in this document and FIG. 5B shows the measured scan probability for a sensor field of view.

FIG. 6A is an example simulated scan cell detection probability S using some embodiments described in this document and FIG. 6B shows the measured scan cell detection probability.

FIG. 7A shows an autonomous vehicle near a drop off, which should register as an occlusion.

FIG. 7B shows the drop off visually from the vehicle point of view.

FIG. 8 shows the results from a field according to some embodiments.

FIG. 9 shows an illustrative computational system for performing functionality to facilitate implementation of embodiments described in this document.

FIG. 10 illustrates a block diagram of an example autonomous vehicle communication system of the present disclosure.

FIG. 11 is a side view of an autonomous yard truck according to some embodiments.

FIG. 12 is a perspective view of an autonomous mower according to some embodiments.

FIG. 13 is a side view of an autonomous tractor according to some embodiments.

### DETAILED DESCRIPTION

Autonomous vehicle systems rely on exteroceptive sensors to navigate an environment. For example, 2D or 3D scanning technologies can be used to generate a point cloud map or other representation of a sensor field of view within an operating environment. Environmental conditions, in some situations, may prevent the autonomous vehicle system from continuously observing all locations within the sensor field of view. Conditions such as smoke, rain, fog, dust, dirt, and other environmental conditions may momentarily and unpredictably obscure the sensor field of view. As the autonomous vehicle navigates the environment, this loss in perception may impede the ability of the system to accurately identify the location of the autonomous vehicle within the environment. Additionally, such conditions may prevent the system from identifying obstacles that enter the environment (e.g., animals, people, other vehicles, or other obstacles). Conventionally, one approach to handling this problem is to prevent or impede movement of the autonomous vehicle whenever observational loss occurs. However, this may lead to increased delays resulting in decreased efficiency including to the point of vehicle operational inefficacy.

A method for navigating an autonomous vehicle is disclosed that relies on collecting observational data and implementation of a time threshold to increase navigational confidence of the autonomous vehicle. Autonomous vehicles rely on exteroceptive sensors to gather information about the environment. Many sensor processing algorithms focus on what is explicitly presented in the sensor data. Information may also be garnered by what is inferred by the data. Occlusions, for example, can fall into this category. An occlusion, for example, can include anything that may prevent a sensor from sensing environmental data in a location resulting in some kind of observational loss. For example, an occlusion may include environmental conditions such as smoke, rain, dust, fog, etc., but may also include permanent structures such as earth formations (e.g., undulating terrain that hides other portions of the environment), boulders, trees, buildings, animals, or people that obstruct the sensor field of view.

Despite observational loss, the autonomous vehicle may infer data based on previously collected observational data. In some embodiments, data may be inferred if previously collected observational data was obtained within a particular time threshold. For example, if a sensor becomes momentarily occluded the system may continue to rely on previously collected sensor data (e.g., from the last several seconds or minutes) to continue to navigate the autonomous vehicle. This may enable a system to continue to navigate an autonomous vehicle with reasonable confidence of vehicle and operational safety, resulting in fewer delays and increased operational efficiency. However, if non-occluded sensor data is not available within the time threshold (i.e., if the elapsed time since non-occluded sensor data was collected is equal to or greater than the time threshold), then the system may not rely on the previously collected sensor data.

Alternatively, or additionally, when an occlusion occurs, a remote operator may be presented with sensor data (e.g., a camera image) associated with the sensor field of view. The remote operator may examine the sensor data to confirm that an area is free from obstacles. Input or other indications associated with or provided by the remote operator may verify to the system the presence (or lack thereof) of an obstacle in the environment and/or path of the vehicle and which may enable the system to continue directing the autonomous vehicle. For example, the indication associated with the remote operator may comprise input from the remote operator or an indication that the remote operator is currently examining the sensor data and/or that no obstacle is present in the operating environment.

The sensor field of view within the operating environment may be represented with an occlusion probability map. The occlusion probability map may comprise a grid of a plurality of cells, with each cell pertaining to a location within the sensor field of view. Each cell may contain an occlusion probability value that represents the probability that the sensor view of the location associated with the cell is occluded (i.e., not observed). The occlusion probability values may correspond to states of the cell, such as an Unknown, Occluded, Likely Occluded, Not Likely Occluded, or Non-Occluded states. The occlusion probability of each cell, or of a subset of cells, of the plurality of cells may be initialized to a particular value. For example, the occlusion probability may be initialized to a value corresponding to an Unknown state of the cell. The occlusion probability of the above cells may be initialized at the beginning of the vehicle operation, after a pause in the operation, or at any time based on input from a remote operator.

Cells may be considered “observed” if the location of the operating environment associated with the cell can be accurately and/or clearly viewed by the sensor. An occlusion (e.g., environmental conditions such as dust, rain, or smoke, as well as obstacles) may interfere with the sensor field of view such that the cell is considered “partially observed” (wherein only a part of the location associated with the cell can be accurately and/or clearly viewed by the sensor) or “non-observed” (wherein all parts of the location associated with the cell cannot be accurately and/or clearly viewed by the sensor).

In some embodiments, the method for navigating the autonomous vehicle may include several steps occurring at different times. In one example, at a first time, the autonomous vehicle may receive observed sensor data from a sensor (e.g., from a sensor on the autonomous vehicle). The sensor data may be “observed” in that it is non-occluded sensor data and that the sensor data represents a clear view of the operating environment. For example, observed sensor data may be sensor data that may be relied upon in selecting paths for navigating the autonomous vehicle. The sensor data (whether “observed” or “occluded”) may comprise data received from a 3D LiDAR sensor, a 2D LiDAR sensor, or other sensor of the autonomous vehicle.

The observed sensor data may be sensor data pertaining to at least a subset of cells within the plurality of cells and may represent that the location(s) associated with the subset of cells is non-occluded and observed by the sensors. When the observed sensor data is received, the occlusion probability of the subset of cells may be set to a value associated with an observed state (e.g., Non-Occluded or a Not Likely Occluded state). During this time, the sub-systems of the autonomous vehicle (e.g., steering and/or speed control systems disclosed below) may drive the autonomous vehicle along a path through an area in the environment, including those areas associated with the subset of cells pertaining to the observed sensor data.

At a second time after the first time, the autonomous vehicle may receive occluded sensor data from the sensor associated with the subset of cells. The sensor data may be “occluded” in that an occlusion obscures the sensor field of view and prevents the operating environment from being observed. That is, the occluded sensor data may show that at least the subset of cells has not been observed.

The autonomous vehicle may then determine an elapsed time between the first time and the second time. If the elapsed time between the first time and the second time is less than a time threshold, then autonomous vehicle may continue to rely on the observed sensor data (and/or the occlusion probability set at the first time) for navigation. That is to say, if the observed sensor data is relatively recent (i.e., within the time threshold) then the system may consider the observed data reliable and that if no obstacles were detected in locations associated with the subset of cells recently (i.e., at the first time) then there continues to be a strong probability that no obstacles are present in these locations at the present moment (i.e., at the second time). Specifically, the occlusion probability of the subset of cells may be set to the occlusion probability of the subset of cells set at the first time.

The system may rely on the observed sensor data to a greater extent the shorter the elapsed time between the first and second times. For example, if the elapsed time is below the time threshold, the system may set the occlusion probability of the cell or subset of cells to the occlusion probability value assigned to the subset of cells at the first time adjusted by some amount that depends on the elapsed time.

If the elapsed time is less than the time threshold, the sub-systems of the autonomous vehicle may continue to drive the autonomous vehicle along a path through an area in the environment, including those areas associated with the subset of cells pertaining to the observed sensor data received at the first time.

At a third time after the second time, the autonomous vehicle may receive a second set of occluded sensor data from the sensor associated with the subset of cells. However, in this instance the elapsed time between the third time and the first time may be equal to or greater than time threshold. The system may then not rely on the observed sensor data associated with the subset of cells received at the first time. In some instances, the occlusion probability of the subset of cells may then be set to a value associated with an Unknown, Occluded, or Likely Occluded state. The sub-systems of the autonomous vehicle may then stop the autonomous vehicle from driving along a path through the area in the environment associated with the second set of occluded sensor data.

In some embodiments, but particularly those in which the occlusion probability of the subset of cells are set to a value associated with an Unknown, Occluded, or Likely Occluded state, sensor data may be sent to a remote operator. The remote operator may examine the sensor data (e.g., a camera image associated with the sensor field of view) to verify that no obstacles are present in the field of view or that the selected path of the autonomous vehicle is free from obstacles.

The autonomous vehicle system may receive an indication associated with the remote operator (e.g., input from the remote operator or an indication that the remote operator is currently viewing a camera image associated with the sensor field of view). The indication may denote that no obstacle is present within the sensor field of view (or present along the path). In such instances, the system may set the occlusion probability of the subset of cells to a different value. For example, after an indication associated with the remote operator is received, the occlusion probability may be changed from a value associated with an Unknown, Occluded, or Likely Occluded state to a value associated with a Non-Occluded or Not Likely Occluded state. The autonomous vehicle sub-systems may then continue to drive the autonomous vehicle along the path under supervision of the remote operator, for example, until non-occluded sensor data may be received.

In instances wherein the occlusion probability of the subset of cells is set to a value associated with an Unknown, Occluded, or Likely Occluded state, paths generated for navigating the autonomous vehicle containing the subset of cells may be excluded in favor of paths that do not contain the subset of cells. In response to the occlusion probability value being changed from the Occluded state to the Not Likely Occluded state (e.g., resulting from input by the remote operator indicating that no obstacle was present at the environmental location associated with the subset of cells), the autonomous vehicle may be directed along the path containing the subset of cells despite the occluded sensor field of view.

An obstacle may be defined as a phenomenon present in the environment that may interfere with the safe operation of the autonomous vehicle. Although obstacles may often effectively occlude the sensor field of view, not all obstacles are occlusions. When an obstacle is sensed within the sensor field of view, the autonomous vehicle may not have an accurate representation of the environment. Occlusions, for example, can be seen as shadows in LiDAR data. While the sensor data itself does not indicate what is in the occluded areas, occlusions can represent negative obstacles such as drop-offs or areas behind large obstacles. These areas are important to identify for autonomous vehicle obstacle detection and avoidance to work properly.

In some embodiments, point cloud data generated from an autonomous vehicle by a 3D LiDAR, structured light, or stereo camera system (or any other system) may include information about the objects within a field of view. Due to the distribution of the points in each point cloud, for example, the current sensor field of view may be inferred. If the current sensor field of view does not match an ideal sensor field of view, it may, for example, indicate that something may be occluding the sensor. Some embodiments include algorithms, processes, methods, or systems that model the probability of sensor occlusion in a map by incorporating an ideal sensor field of view model compared against sensor data over time.

In some embodiments, an occlusion mapping algorithm may model an area around an autonomous vehicle as a grid map where each grid cell represents the probability of occlusion from one or more sensors mounted on the vehicle. This can be an occlusion probability map that may be updated regularly. Updating the occlusion probability map may require knowledge of the sensor field of view (FOV), which may be represented as a probability mass function centered around the vehicle.

An inertially-based coordinate system may be used for the occlusion mapping, which may be denoted by row, column grid coordinates (r, c). The occlusion mapping may also use a vehicle-centric coordinate system for the sensor field-of-view model, denoted by row, column grid coordinates (\hat{r}, ĉ). Embodiments of the invention may be used in either coordinate system.

In some embodiments, it can be assumed that only one sensor data stream can be input into this algorithm. This may, for example, be generalized to any number of sensors by running an update equation for each sensor at their respective scene scan rate. Each sensor may retain its own FOV model but share the occlusion probability map.

In some embodiments, a probabilistic model can describe the probability of detection within an ideal sensor field of view (FOV). A 2D detection probability grid map G can be defined. g_{\hat{r},ĉ} can be used to denote the detection probability in the grid cell at index (\hat{r}, ĉ) relative to the vehicle. This map may be in the vehicle frame, assuming the sensor mounting is static and/or the sensor scanning pattern is repeating over some small time period ΔT. The grid map G may represent a probability mass function (pmf) of getting a sensor return in each grid cell. That is, Σ_{Gg}_{_{\hat{r},ĉ}}=1.0. It can be viewed as a point density function.

There are several methods for populating G. These may include, for example, using empirical data to estimate each cell value using normalized histogram counts or, as another example, simulating the sensor field of view based on an ideal model. In either case, a 2D plane at ground height may represent an ideal, non-occluded world the sensor FOV model is based on.

With the pmf grid G, the probability that a grid cell at index (\vec{r}, \vec{c}) is detected by any point when N points are sensed in a scan of the area can be determined. For example, another grid S, the cell scan detection probability grid, can be created to store this information with each cell denoted as S_{\hat{r},ĉ}. This grid may be populated from the information in G. It can be assumed that each point in a FOV scan is sensed independently of one another. This can be modeled by a Binomial distribution with parameters N and g_{\hat{r},ĉ}, where it determines the probability of a single cell detected in any of N point samples. Because these points may not be truly independent of one another, an aggressiveness scale factor α may be introduced to tune the system for reasonable results. This aggressiveness factor may change the effective number of points sampled in a scan of the scene to better approximate the points as a random process. With the aggressiveness factor, the cell scan detection probability for each cell in grid S may be given by

$${S}_{\hat{r} , \hat{c}} = 1 - {( 1 - {g}_{\hat{r} , \hat{c}} )}^{α N} .$$

In some embodiments, the grids G and S may be defined in a vehicle-frame. Using the vehicle pose at a given time, the frame may be converted from the vehicle frame coordinates (\hat{r}, ĉ) to corresponding inertial frame coordinates (r, c). For instance, g_{\vec{r},\vec{c}} or S_{\vec{r},\vec{c}} refers to the vehicle frame coordinates and g_{r,c} or S_{r,c} refers to the inertial frame coordinates with the same vehicle in mind.

In this way, for example, the grids G and S may need only be computed once and stored. When querying between inertial-frame and vehicle-frame grid coordinates, various types of sampling interpolation may be used such as, for example, nearest neighbor or bilinear interpolation.

In some embodiments, a 2D occlusion probability grid map M can be defined to denote, for example, the occlusion probability for grid cell at index (r, c) in the inertial frame at time k. For example:

$${m}_{r , c}^{k} = P ( {Cell}_{r , c} = Occluded \vert {z}_{r , c}^{k - 1} , {m}_{r , c}^{k - 1} , {s}_{r , c} ) .$$

Each cell's occlusion probability,

$${m}_{r , c}^{k} ,$$

may be based on the cell's prior occlusion probability,

$${m}_{r , c}^{k - 1} ,$$

the currently observed data

$${z}_{r , c}^{k - 1} ,$$

and the cell scan detection probability s_{r,c}. In some embodiments, each cell's occlusion probability may be spatially-independent from one another. In some embodiments, each cell may be an independent Markov model depending on either or both the current measurements and the previous state. In some embodiments, each cell may be spatially-dependent on one another and/or can be modeled with a Markov random field. In some embodiments, each cell in the map may be initialized to some small, non-zero occlusion probability ϵ. The resolution of this grid need not match the resolution of the corresponding sensor FOV grid G.

Updates to the map m can occur every ΔT seconds at time

$$k = \frac{{T}_{current} - {T}_{initial}}{Δ T} ,$$

where ΔT is the scene scan period. Between updates, for example, incoming point clouds may be transformed from the sensor frame into the inertial frame and concatenated into a single point cloud C^{k}.

At each update k, the currently observed cells can be determined based on the inertially-referenced point cloud C^{k}. In some embodiments, a binary indicator list

$${z}_{r , c}^{k}$$

can be formed. For example, for each point in cᵢ∈C^{k}, the corresponding grid cell index (r, c) and

$${z}_{r , c}^{k} = 1$$

can be added to the list. Cells that fall within the vehicle bounding box, for example, may be ignored. Once the list of observed cells is created, for example, all other cells may be known to be currently unobserved,

$${z}_{r , c}^{k} = 0.$$

In some embodiments, these need not explicitly be added to the list of currently observed cells

$$( e . g . , {z}_{r , c}^{k} )$$

as their value is known by exclusion. In some embodiments, all points in C^{k} may automatically be counted as observed. In some embodiments, only points approximately at ground level may be counted as observed. In some embodiments, two or more points may be counted per cell. In some embodiments, a cell is counted as observed if at least one point falls within the cell and does not fall within the vehicle bounding box.

In some embodiments, once the current binary observations are determined, the grid cell probabilities may be updated. For each grid cell,

$${m}_{r , c}^{k} ,$$

in the map m, the corresponding current observation indicator

$${z}_{r , c}^{k}$$

can be examined. If the cell is currently observed

$$( e . g . , {z}_{r , c}^{k} = 1 ) ,$$

this cell is not occluded, and the probability of occlusion is set to zero,

$${m}_{r , c}^{k} = 0.$$

currently observed

$$( {z}_{r , c}^{k} = 0 ) ,$$

there are at least two options: the cell has already been observed or the cell has never been observed. If the cell has already been observed, it already has zero occlusion probability and this is propagated,

$${m}_{r , c}^{k} = {m}_{r , c}^{k - 1} = 0.$$

If the cell has never been observed, then the update equation may be executed.

The update equation, for example, may examine the previous occlusion probability

$${m}_{r , c}^{k - 1}$$

and the scan cell detection probability s_{r,c}. It can be assumed, for example, that successive s_{r,c} may be independent from each other. For example, if the cell scan detection probabilities are independent (or assumed to be independent through a heuristic, for example, as described below), the update equation may be performed. If the cell scan detection probability at time k is not independent of the cell scan detection probability at time k−1, then the update equation may not apply, and the previous value propagates through,

$${m}_{r , c}^{k} = {m}_{r , c}^{k - 1} .$$

The update can be found from:

$${m}_{r , c}^{k} = 1 - ( 1 - {s}_{r , c} ) ( 1 - {m}_{r , c}^{k - 1} ) . \qquad equation ( 1 )$$

In some embodiments, this update equation may describe a sequence of Bernoulli random variables that are independent but not identically-distributed due to the parameter s_{r,c}, which changes with each iteration k. This equation, for example, is written in a recursive format and/or may represent the probability that a cell is not observed over a sequence of observation probabilities. If the cell is not in the sensor field of view, for example, then s_{r,c}=0, and the probability simply propagates,

$${m}_{r , c}^{k} = {m}_{r , c}^{k - 1} .$$

In some embodiments, the update equation may describe a binary Bayes filter. This may allow the system to effectively “forget” that a cell has been observed after multiple observations of an area outside the point cloud but within the sensor field of view have been made. That is, the binary Bayes filter may aid in effectively decreasing the occlusion probability of the cell after the cell has been, but is not currently, observed (e.g., when the cell becomes occluded). The binary Bayes filter may employ not only the sensor FOV model (providing the probability of detection within the field of view) but may also employ a probability of false detection model within and outside the field of view. When the cell is observed, the binary Bayes filter update equation may be represented by the following equation:

$${m}_{r , c}^{k} = \frac{{s}_{f} {m}_{r , c}^{k - 1}}{{s}_{f} {m}_{r , c}^{k - 1} + {s}_{r , c} ( 1 - {m}_{r , c}^{k - 1} )} .$$

When the cell is not observed, the binary Bayes filter update equation may be represented as:

$${m}_{r , c}^{k} = \frac{( 1 - {s}_{f} ) {m}_{r , c}^{k - 1}}{( 1 - {s}_{f} ) {m}_{r , c}^{k - 1} + ( 1 - {s}_{r , c} ) ( 1 - {m}_{r , c}^{k - 1} )} .$$

In both of the above equations, s_{f} may represent the probability of false detection for the cell at (r, c). Alternatively, or in addition to the Bernoulli random variables, the Markov model, and the binary Bayes filter described above, the probability update function may rely on a Dempster-Shafer model.

In some embodiments, because the sensor FOV model may not (typically) represent a random process, at least on some level of abstraction, if a vehicle is stationary, successive s_{r,c} may not be independent. An independence heuristic may be used, for example, which may allow for an approximation when successive s_{r,c} may be independent. Because a sensor's detections are usually spatially-repeatable (i.e. when a sensor is stationary, it gets returns from approximately the same grid cells in each scan), the independence heuristic may be based on sensor movement. Since the previous iteration update, if the sensor has moved some fractional (e.g. half) amount of the grid cell size then the successive s_{r,c} values are assumed to be independent, and equation (1) applies. If this movement is not detected, we assume no independence and the cells in map M are not updated per the description above. A similar rule can be created for heading or rotational changes.

At each update, the map is sent to an obstacle detection and avoidance system providing information about occlusions. Occlusion information can help infer non-drivable areas.

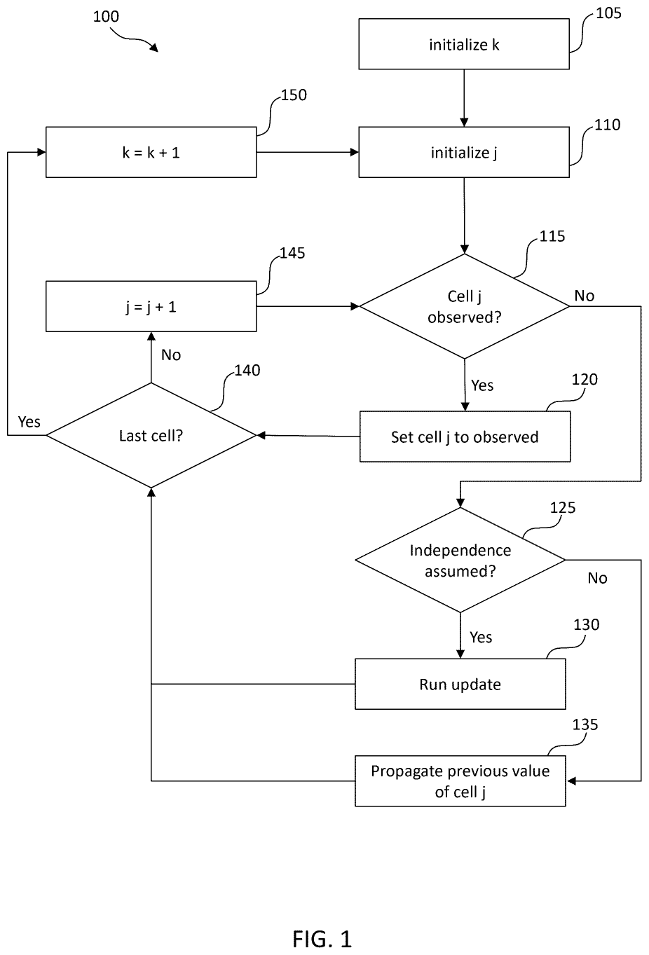

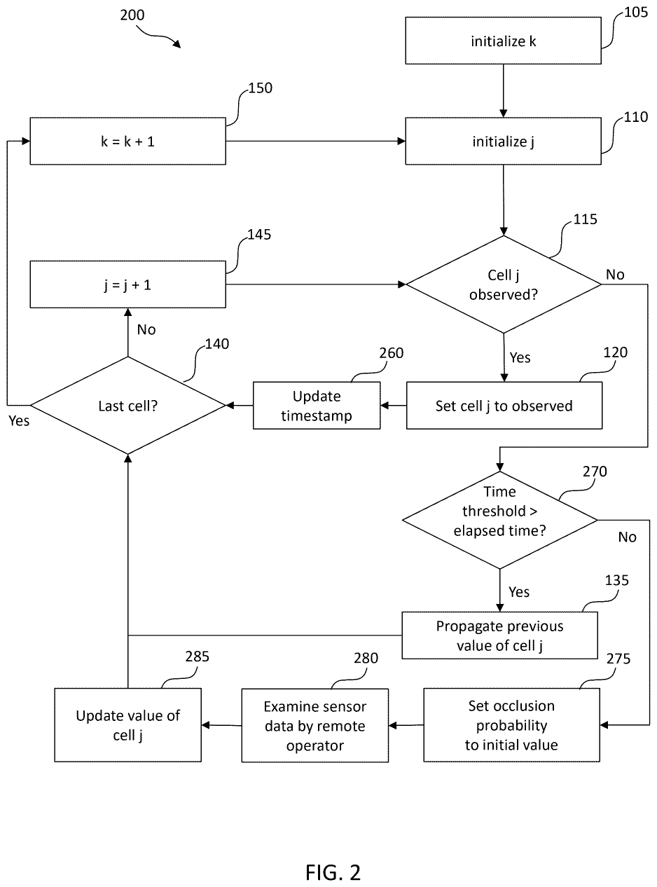

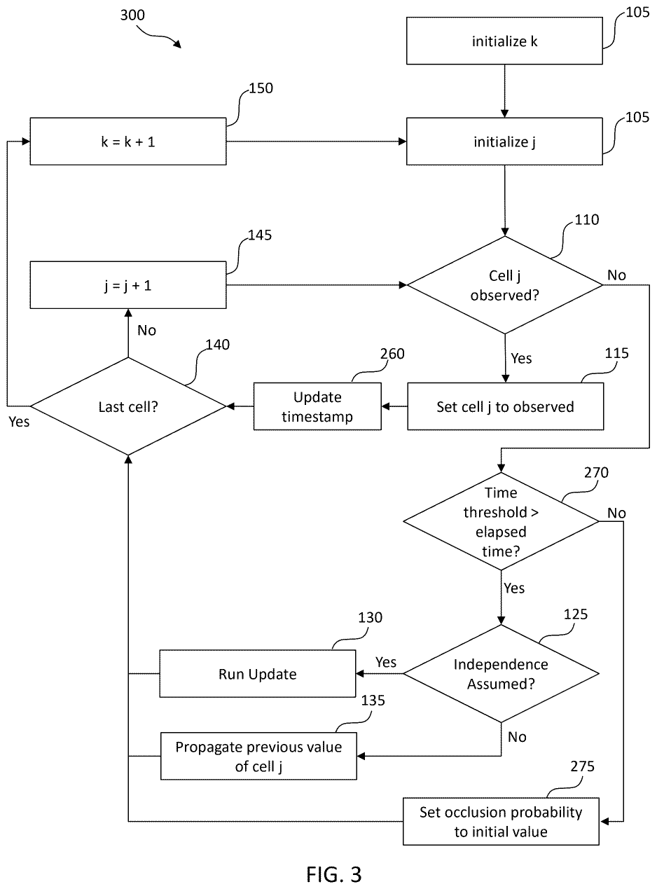

FIG. 1 is a flowchart of an example process 100 for updating a cell according to some embodiments. The process 100 (as well as processes 200 and 300 illustrated in FIGS. 2 and 3, respectively) may include additional blocks, or may have blocks removed. In addition, blocks may be performed in any order. Process 100 (and/or processes 200 and/or 300) may be executed by computational system 900.

The process 100 starts at blocks 105, 110 where the counter, k, is initialized to represent the first cell within a grid map M. In some embodiments, each block in the process 100 (or in processes 200 and/or 300) may operate on every cell within a grid map M. In such embodiments, the counter, k, may represent each time sequence for updating the grid map M.

At block 115, the process 100 determines whether the cell has been or is observed. As noted above, various techniques may be used to determine whether a cell has been or is observed. In some embodiments, all points in C^{k} may automatically be counted as observed. In some embodiments, points approximately at ground level may be counted as observed. In some embodiments, two or more points may be counted per cell. As another example, a cell is counted as observed if at least one point falls within the cell and does not fall within the vehicle bounding box.

If the cell, C^{k}, is considered observed, then the process 100 proceeds to block 120, otherwise it proceeds to block 125. At block 120, the cell can be set to observed:

$${m}_{r , c}^{k} = 0 .$$

At block 125, the process 100 determines whether independence can be assumed such as, for example, as discussed above. For example, if the sensor has moved some fractional (e.g. half) amount of the grid cell size then successive s_{r,c} values are assumed to be independent. Various other techniques may be used to show independence. If independence can be assumed, the process 100 proceeds to block 130. If independence cannot be assumed, then process 100 proceeds to block 135.

At block 130, an update can be executed such as, for example, as shown in equation (1). After the update has been executed, process 100 proceeds to block 140 from where the next cell is selected at block 145 or the counter, k, is incremented at block 150 and process 100 repeats.

At block 135, the previous value may be propagated such as, for example,

$${m}_{r , c}^{k} = {m}_{r , c}^{k - 1} .$$

After block 135, process 100 proceeds to block 140 where the counter, k, is incremented and process 100 repeats.

In some embodiments, at block 140, the process 100 may pause for a predetermined period of time.

FIG. 2 is a flowchart of an example process 200 for updating a cell, according to some embodiments, similar to process 100 of FIG. 1. Similar to process 100, process 200 begins at blocks 105, 110 where the counter, k, and the first cell are initialized within the grid map M. At block 115, the process 100 determines whether the cell has been or is observed. If the cell, C^{k}, is considered observed, then process 200 proceeds to block 120, in which the cell can be set to observed:

$${m}_{r , c}^{k} = 0 .$$

If the cell is set to observed, then at block 260 a timestamp associated with the cell may be updated to the current time (e.g., at time k or at an absolute measure of time). In this manner, the timestamp indicates when the cell, C^{k}, was last observed (i.e., when non-occluded sensor data was recorded). Process 200 may then be updated at block 140 to continue to the next cell at block 145 or increment the counter, k, at block 150.

If the cell is not observed, then process 200 proceeds from block 115 to block 270 where process 200 determines whether a time threshold is greater than an elapsed time. The elapsed time may refer to the difference in time between the current counter or time, k, and the timestamp associated with the cell.

The time threshold may refer to an amount or range of time within which the autonomous vehicle may be safely and/or efficiently operated during Unknown, Occluded, or Likely Occluded states. The time threshold may depend on the operating speed of the autonomous vehicle, the size of the sensor field of view, and/or other configuration parameters. For example, the time threshold may comprise 0.1, 0.2, 0.3, 0.4, 0.5, 1, 2, 3, 4, 5, 10, 20, 30, 45, 60, 120, 180, 240, or 300 seconds, or may comprise a range having any two of the foregoing as endpoints, or may comprise a different amount of time or time range suitable for navigating and/or directing an autonomous vehicle.

The time threshold may vary depending on the location of the cell within the occlusion probability map. For example, the time thresholds associated with cells associated with distances further from the autonomous vehicle may be higher than time thresholds associated with cells associated with distances closer to the autonomous vehicle.

If the time threshold is greater than the elapsed time, process 200 may proceed to block 135 where the previous value of the cell is propagated

$$( i . e . , {m}_{r , c}^{k} = {m}_{r , c}^{k - 1} ) .$$

If the time threshold is not greater than the elapsed time the process 200 may proceed to block 275 where the occlusion probability of the cell is set to the initial value, which may correspond to an Unknown, Occluded, or Likely Occluded state.

In some embodiments, the process 200 may further include block 280 wherein a remote operator examines sensor data associated with the sensor field of view. The examination of sensor data may enable a remote operator to verify that locations in the environment associated with the cell present an obstacle and/or are occluded. For example, in instances where dust present in the environment may interfere with 2D or 3D LiDAR sensors, a remote operator may examine a camera image associated with the cell to verify if the location associated with the cell is occluded. Additionally, or alternatively, the remote operator may examine LiDAR or radar data to verify the state of the location associated with the cell. In some embodiments, the remote operator may examine partially or completely processed LiDAR data represented by the probability map or by an occupancy grid that uses received sensor data to estimate the probability of an obstacle present at the location associated with the cell.

The process 200 may proceed thereafter to block 285 where the occlusion probability of the cell may be updated based on input associated with the remote operator. For example, the occlusion probability of the cell may be set to a value associated with a Not Likely Occluded state or a Not Occluded state based on input from the remote operator after examining the sensor data. Alternatively, the occlusion probability of the cell may be set to a value associated with an Unknown, Likely Occluded, or Occluded state based on input from the remote operator.

In this manner, the operation of the autonomous vehicle by the system may continue with reasonable safety and efficiency despite occlusion of the one or more sensors of the vehicle. In some embodiments, block 270 may determine whether the time threshold is greater than or equal to the elapsed time.

FIG. 3 is a flowchart of an example process 300 for updating a cell according to some embodiments. Process 300 illustrates a combination of the unique features of processes 100 and 200 illustrated in FIGS. 1 and 2, respectively. Similar to process 200, process 300 can determine whether the cell was observed at block 115. If the cell is observed the cell can be set to observed

$$( e . g . , {m}_{r , c}^{k} = 0 )$$

at block 120. Thereafter, the process 300 may proceed to block 260 to update the timestamp associated with the cell.

If the cell is not observed, process 300 may proceed to block 270 where process 300 determines whether the time threshold is greater than an elapsed time between the current time and the timestamp associated with the cell. If the time threshold is not greater than the elapsed time, then process 300 may proceed to block 275 wherein the occlusion probability of the cell is set to the initial value. If the time threshold is greater than the elapsed time, then process 300 may continue to block 125 which determines whether cell independence may be assumed. If cell independence can be assumed, then process 300 may proceed to block 130 where an update can be executed. If cell independence cannot be assumed, then process 300 may continue to block 135 wherein the previous value of the cell is propagated.

In other embodiments, if the cell is not observed the process 300 may proceed from block 115 to block 125 where the process 300 determines whether cell independence may be assumed. If cell independence can be assumed, then process 300 may proceed to block 130 where an update can be executed. Otherwise (i.e., if cell independence cannot be assumed), process 300 may proceed from block 125 to block 270 where it is determined whether the time threshold is greater than the elapsed time. If the time threshold is greater than the elapsed time, then the process 300 may continue to block 135 wherein the previous value of the cell is propagated. If the time threshold is not greater than the elapsed time, then the process 300 may continue to block 27 wherein the occlusion probability associated with the cell is set to the initial value.

In some embodiments, obstacle detection and avoidance systems on autonomous vehicles can include the use of a 2D drivability grid D. This grid may represent if a vehicle can safely traverse some area. The cells nearby a projected or assigned path may be repeatedly checked for drivability. If the path or cell is not drivable, the obstacle avoidance system is configured to either stop for or maneuver around the non-drivable area.

In some embodiments, an occlusion map probability can represent one of four states: (1) Observed, (2) Unknown, (3) Not Likely Occluded, and (4) Likely Occluded. The mapping between each cell occlusion probability

$${m}_{r , c}^{k}$$

and examples of these states are shown in the following table:

| Cell State | Probability Range |
|---|---|
| Observed | ${m}_{r , c}^{k} = 0$ |
| Unknown | ${m}_{r , c}^{k} = ∈$ |
| Not Likely Occluded | $∈ < {m}_{r , c}^{k} < {O}_{thresh}$ |
| Likely Occluded | ${O}_{thresh} < {m}_{r , c}^{k} < 1$ |

The occlusion threshold, Oₜₕᵣₑₛₕ, which differentiates Not Likely Occluded from Likely Occluded is chosen such that ϵ<Oₜₕᵣₑₛₕ<1, and may be tunable for the sensor, operating speed, and/or other configuration parameters. In some embodiments, the Likely Occluded state can be considered a non-drivable state, and the other states may be considered drivable.

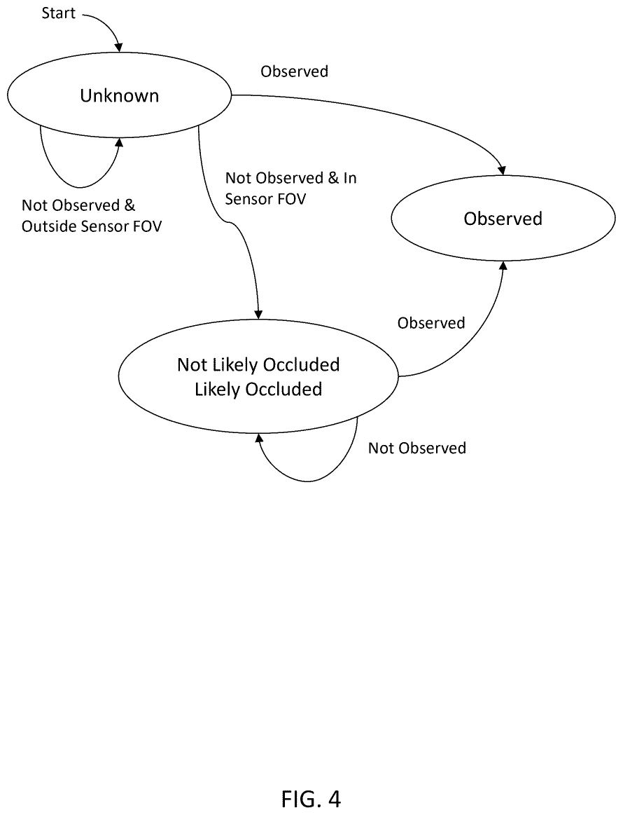

FIG. 4 is a diagram of an occlusion state transition model for each cell according to some embodiments. States Not Likely Occluded and Likely Occluded are combined in this diagram because they are only differentiated by a user-defined threshold.

In some embodiments, the probability-to-state mapping may operate on each cell individually. In some embodiments, however, because small, occluded areas may not be considered non-drivable for a particular application, spatial voting or filtering can take place. Different methods such as k-nearest-neighbors classification, the number of Likely Occluded cells in a Moore Neighborhood, or other techniques can be used to ensure that only larger Likely Occluded areas are marked as non-drivable in the drivability grid. In some embodiments, a spatial voting process based on the number of Likely Occluded cells in the Moore Neighborhood can be used.

As shown in FIG. 4, a cell starts off in the Unknown state and remains in the Unknown state if it is determined that the cell is Not Observed and Outside the Sensor FOV. If the cell is Observed, then the state transitions to the Observed state. If a cell is in the Unknown state, Not Observed, and In the Sensor FOV, then the cell transitions to either the Likely Occluded State or the Not Likely Occluded State depending on the threshold value. The cell remains in either of these two states until the cell becomes observed whereupon the cell transitions to the Observed state.

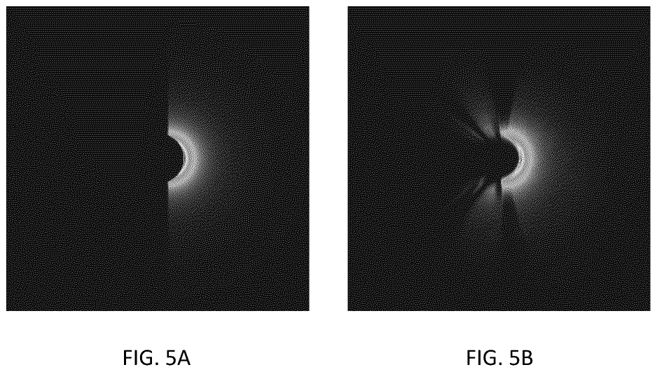

FIG. 5A is an example simulated scan probability for a sensor field of view grid G using some embodiments described in this document and FIG. 5B shows the measured scan probability for a sensor field.

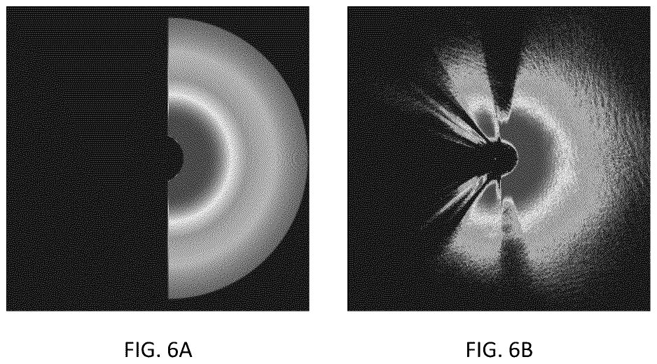

FIG. 6A is an example simulated scan cell detection probability S using some embodiments described in this document and FIG. 6B shows the measured scan cell detection probability.

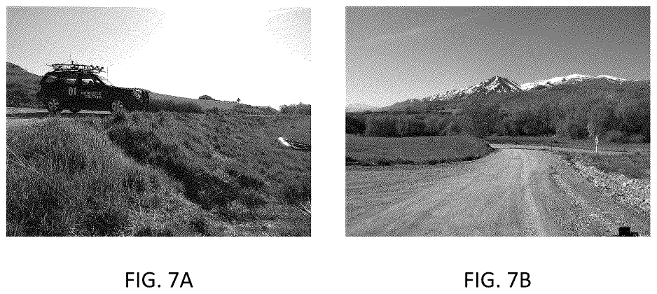

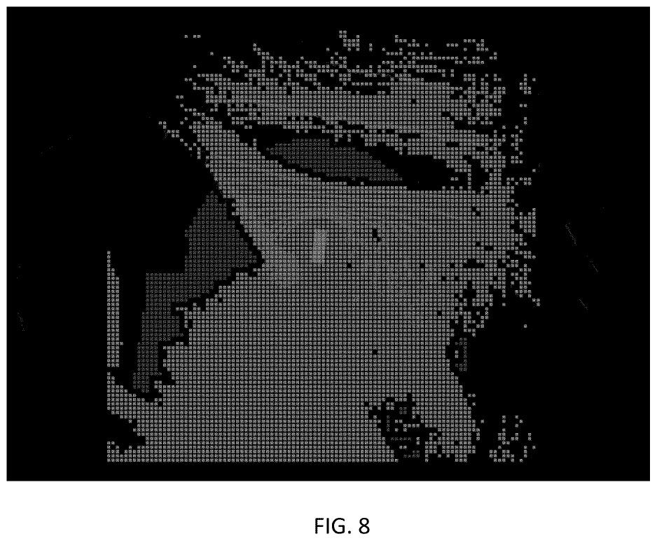

FIG. 7A shows an autonomous vehicle approaching a drop off, which should register as an occlusion. FIG. 7B shows the drop off visually from the vehicle point of view. FIG. 8 shows the results. Green cells are Observed; red cells have been determined to be Likely Occluded. The blue cells are those registered by the LiDAR mapping system. Unknown and Not Likely Occluded cells are not shown.

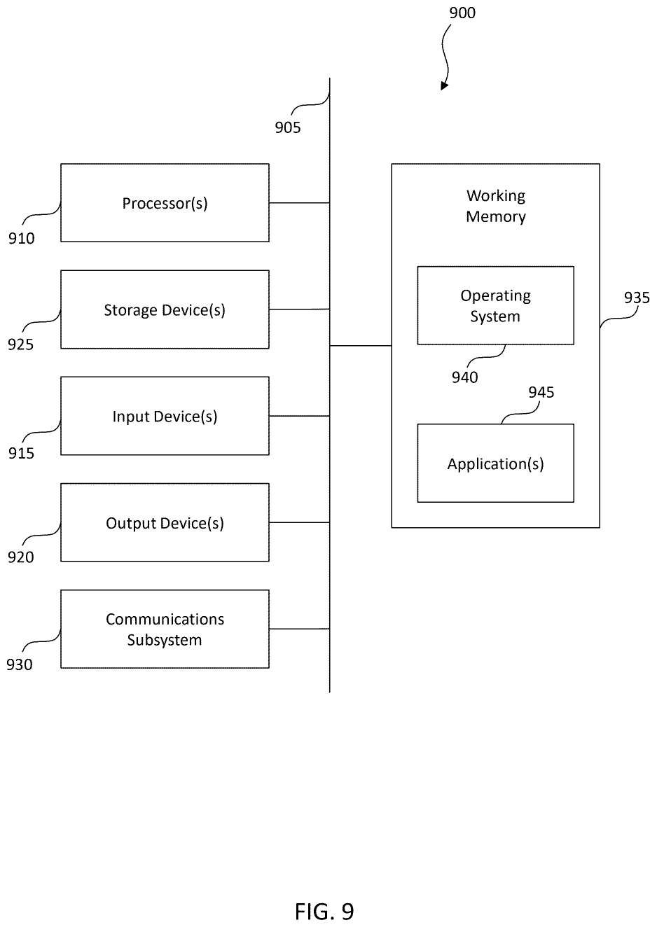

The computational system 900, shown in FIG. 9, can be used to perform any of the embodiments of the invention. For example, computational system 900 can be used to execute processes 100, 200, and/or 300. As another example, computational system 900 can be used to perform any calculation, identification and/or determination described here. Computational system 900 includes hardware elements that can be electrically coupled via a bus 905 (or may otherwise be in communication, as appropriate). The hardware elements can include one or more processors 910, including without limitation one or more general-purpose processors and/or one or more special-purpose processors (such as digital signal processing chips, graphics acceleration chips, and/or the like), one or more input devices 915, which can include without limitation a mouse, a keyboard and/or the like, and one or more output devices 920, which can include without limitation a display device, a printer, and/or the like.

The computational system 900 may further include (and/or be in communication with) one or more storage devices 925, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable, and/or the like. The computational system 900 might also include a communications subsystem 930, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 930 may permit data to be exchanged with a network (such as the network described below, to name one example), and/or any other devices described herein. In many embodiments, the computational system 900 will further include a working memory 935, which can include a RAM or ROM device, as described above.

The computational system 900 also can include software elements, shown as being currently located within the working memory 935, including an operating system 940 and/or other code, such as one or more application programs 945, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 925 described above.

In some cases, the storage medium might be incorporated within the computational system 900 or in communication with the computational system 900. In other embodiments, the storage medium might be separate from a computational system 900 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 900 and/or might take the form of source and/or installable code, which, upon compilation and/or installation on the computational system 900 (e.g., using any of a variety of generally available compilers, installation programs, compression/decompression utilities, etc.) then takes the form of executable code.

The computational system 900 may be configured to operate an autonomous vehicle platform. The vehicle platform may comprise a steering mechanism in communication with the processor, where the processor communicates steering commands to the steering mechanism based on the occlusion probability. The vehicle platform may comprise a braking mechanism in communication with the processor, where the processor communicates braking commands to the braking mechanism based on the occlusion probability.

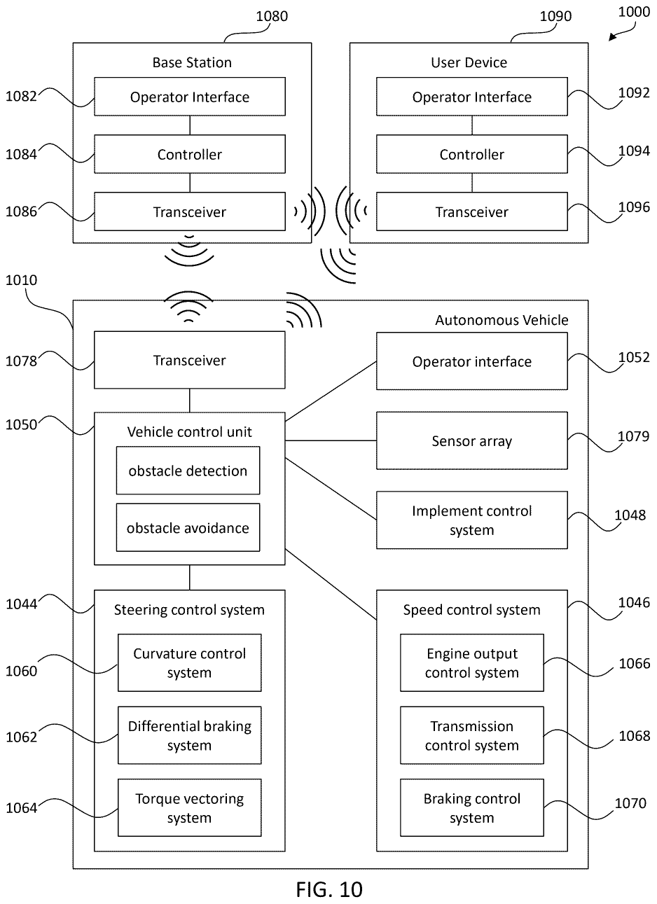

FIG. 10 is a block diagram of a communication and control system 1000 that may be utilized in conjunction with the systems and methods of the disclosure. The communication and control system 1000 may include a vehicle control unit 1050 which may be mounted on an autonomous vehicle 1010. The autonomous vehicle 1010, for example, may include a yard truck, loader, wheel loader, track loader, dump truck, digger, backhoe, forklift, mower (e.g., lawn, field, or brush mower), or other vehicle. The communication and control system 1000, for example, may include any or all components of computational system 900 shown in FIG. 9.

For example, the autonomous vehicle 1010 may include a steering control system 1044 that may control a direction of movement of the autonomous vehicle 1010. The steering control system 1044, for example, may include any or all components of computational system 900 shown in FIG. 9.

The autonomous vehicle 1010, for example, may include a speed control system 1046 that controls the speed, acceleration, and deceleration of the autonomous vehicle 1010. The speed control system 1046, for example, may control the speed of the autonomous vehicle 1010 based on map data, control algorithms, obstacle detection, start and/or stop points, input from the operator (e.g., a remote operator), etc. The speed control system 1046, for example, may include any or all components of computational system 900 shown in FIG. 9.

The autonomous vehicle 1010, for example, may include an implement control system 1048 that may control operation of an implement towed by the autonomous vehicle 1010 or integrated within the autonomous vehicle 1010 or coupled to the autonomous vehicle 1010. The implement control system 1048 may, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 1048, for example, may include any or all components of computational system 900 shown in FIG. 9.

The vehicle control unit 1050 may be communicatively coupled with the steering control system 1044, the speed control system 1046, and/or the implement control system 1048. The vehicle control unit 1050, for example, may include any or all of the components shown in FIG. 9. The vehicle control unit 1050, for example, may be integrated into a single controller or may include a plurality of distinct components or controllers. The vehicle control unit 1050 may also be coupled with one or more sensors from the sensor array 1079 and receive sensor data from the sensor array 1079.

The vehicle control unit 1050, for example, may be used to control various aspects of the vehicle 1010 such as, for example, sending instructions to the steering control system 1044, implement control system 1048, speed control system 1046, etc. The vehicle control unit 1050, for example, may include a vehicle artificial intelligence (VAI) that may include one or more processors that execute one or more algorithms, including processes 100, 200, and/or 300 disclosed above.

The vehicle control unit 1050, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensory array 1079 or from base station 1080 (described below).

The vehicle control unit 1050, for example, may be an electronic controller with electrical circuitry configured to process data from the various components of the autonomous vehicle 1010. The vehicle control unit 1050 may include a processor, such as the processor 910, and a working memory 935. The vehicle control unit 1050 may also include one or more storage devices, storage media, and/or other suitable components of computational system 900. The processor may be used to execute software, such as software for calculating drivable path plans. Moreover, the processor may include multiple microprocessors, one or more “general-purpose” microprocessors, one or more special-purpose microprocessors, and/or one or more application specific integrated circuits (ASICS), or any combination thereof. For example, the processor may include one or more reduced instruction set (RISC) processors.

The vehicle control unit 1050, for example, may include a volatile memory, such as random access memory (RAM), and/or a nonvolatile memory, such as ROM (e.g., working memory 935, storage device 925, and/or other computer-readable media). The memory may store a variety of information and may be used for various purposes. For example, the memory may store processor-executable instructions (e.g., firmware or software) for the vehicle control unit 1050 to execute, such as instructions for calculating drivable path plan, and/or controlling the autonomous vehicle 1010 (e.g., for implementing processes 100, 200, or 300 above). The memory may include flash memory, one or more hard drives, or any other suitable optical, magnetic, or solid-state storage medium, or a combination thereof. The memory may store data such as field maps, maps of desired paths, vehicle characteristics, software or firmware instructions and/or any other suitable data.

The steering control system 1044, for example, may include a curvature rate control system 1060, a differential braking system 1062, a steering mechanism, and a torque vectoring system 1064 that may be used to steer the autonomous vehicle 1010. The curvature rate control system 1060, for example, may control a direction of an autonomous vehicle 1010 by controlling a steering control system of the autonomous vehicle 1010 with a curvature rate, such as an Ackerman style autonomous vehicle, 1010 or articulating vehicle. The curvature rate control system 1060, for example, may automatically rotate one or more wheels or tracks of the autonomous vehicle 1010 via hydraulic or electric actuators to steer the autonomous vehicle 1010. By way of example, the curvature rate control system 1060 may rotate front wheels/tracks, rear wheels/tracks, and/or intermediate wheels/tracks of the autonomous vehicle 1010 or articulate the frame of the vehicle, either individually or in groups. The differential braking system 1062 may independently vary the braking force on each lateral side of the autonomous vehicle 1010 to direct the autonomous vehicle 1010. Similarly, the torque vectoring system 1064 may differentially apply torque from the engine to the wheels and/or tracks on each lateral side of the autonomous vehicle 1010. While the illustrated steering control system 1044 includes the curvature rate control system 1060, the differential braking system 1062, and the torque vectoring system 1064, the steering control system 1044 may include one or more of these systems. Further examples may include a steering control system 1044 having other and/or additional systems to facilitate turning the autonomous vehicle 1010 such as an articulated steering control system, a differential drive system, and the like.

The speed control system 1046, for example, may include an engine output control system 1066, a transmission control system 1068, and a braking control system 1070. The engine output control system 1066 may vary the output of the engine to control the speed of the autonomous vehicle 1010. For example, the engine output control system 1066 may vary a throttle setting of the engine, a fuel/air mixture of the engine, a timing of the engine, and/or other suitable engine parameters to control engine output. In addition, the transmission control system 1068 may adjust gear selection within a transmission to control the speed of the autonomous vehicle 1010. Furthermore, the braking control system 1070 may adjust braking force to control the speed of the autonomous vehicle 1010. While the illustrated speed control system 1046 includes the engine output control system 1066, the transmission control system 1068, and the braking control system 1070, the speed control system 1046 may include one or two of these systems. The speed control system 1046, for example, may also include other systems and/or additional systems that may be used to control the speed of the autonomous vehicle 1010.

The implement control system 1048, for example, may control various parameters of the implement towed by and/or integrated within the autonomous vehicle 1010. For example, the implement control system 1048 may instruct an implement controller via a communication link, such as a CAN bus, ISOBUS, Ethernet, wireless communications, and/or Broad R Reach type Automotive Ethernet, etc.

The implement control system 1048, for example, may instruct an implement controller to adjust a penetration depth of at least one ground engaging tool of an agricultural implement, which may reduce the draft load on the autonomous vehicle 1010.

The implement control system 1048, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc.

The implement control system 1048, as another example, may instruct the implement controller to adjust a shovel height, a shovel angle, a shovel position, etc.

The communication and control system 1000, for example, may include a sensor array 1079. The sensor array 1079, for example, may facilitate determination of condition(s) of the autonomous vehicle 1010 and/or the work area. For example, the sensor array 1079 may include one or more sensors (e.g., infrared sensors, ultrasonic sensors, magnetic sensors, tachometer, radar sensors, LiDAR sensors, terahertz sensors, sonar sensors, wheel encoders, cameras, etc.) that monitor a rotation rate of a respective wheel and/or track a ground speed of the autonomous vehicle 1010. The sensors may also monitor operating levels (e.g., temperature, fuel level, etc.) of the autonomous vehicle 1010. Furthermore, the sensors may monitor conditions in and around the work area, such as temperature, weather, wind speed, compass, humidity, and other conditions. The sensors of the sensor array 1079, for example, may detect physical objects in the work area, such as a parking stall, a material stall, accessories, other vehicles, obstacles, environmental features, or other object(s) that may be in the area surrounding the autonomous vehicle 1010.

The sensor array 1079, for example, may include a velocity sensor which may include one or more of an inertial measurement unit, a compass, a GPS sensor, a wheel encoder, a tachometer, a camera, a radar, etc. The sensor array 1079, for example, may also include a steering angle sensor. The velocity sensor, for example, may produce velocity data. Velocity data may include information regarding speed and/or bearing. Velocity data, for example, may also include information regarding the steering angular rate.

The autonomous vehicle 1010 may include an operator interface 1052 for controlling the vehicle. The operator interface 1052, for example, may be communicatively coupled to the vehicle control unit 1050 and configured to present data from the autonomous vehicle 1010 via a display. Display data may include data associated with operation of the autonomous vehicle 1010, data associated with operation of an implement, a position of the autonomous vehicle 1010, a speed of the autonomous vehicle 1010, a desired path, a drivable path plan, a target position, and/or a current position, etc. The operator interface 1052 may enable an operator to control certain functions of the autonomous vehicle 1010 such as starting and stopping the autonomous vehicle 1010, inputting a desired path, etc. The operator interface 1052, for example, may enable the operator to input parameters that cause the vehicle control unit 1050 to adjust the drivable path plan. For example, the operator may provide an input requesting that the desired path be acquired as quickly as possible, that an off-path normal error be minimized, that a speed of the autonomous vehicle 1010 remain within certain limits, and/or that a lateral acceleration experienced by the autonomous vehicle 1010 remain within certain limits, etc. In addition, the operator interface 1052 (e.g., via the display, or via an audio system (not shown), etc.) may alert an operator if the desired path cannot be achieved, for example.

The communication and control system 1000, for example, may include a base station 1080 having a base station controller 1084 located remotely from the autonomous vehicle 1010. For example, the control functions of the vehicle control unit 1050 may be distributed between the vehicle control unit 1050 of the autonomous vehicle 1010 and the base station controller 1084. The base station controller 1084, for example, may perform a substantial portion of the control functions of the vehicle control unit 1050. For example, a first transceiver 1078 positioned on the autonomous vehicle 1010 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 1086 at the base station 1080. The base station controller 1084, for example, may calculate drivable path plans and/or output control signals to control the curvature control system 1060, the speed control system 1046, and/or the implement control system 1048 to direct the autonomous vehicle 1010 toward the desired path, for example. The base station controller 1084 may include a processor and memory device having similar features and/or capabilities as the processor and the memory device discussed previously. Likewise, the base station 1080 may include an operator interface 1082 having a display, which may have similar features and/or capabilities as the operator interface 1052 and the display discussed previously.

In some embodiments, one or both of the base station 1080 and/or the autonomous vehicle 1010 may be in communication with a user device 1090. A user device 1090 may include a phone, tablet, laptop, or computer. The user device 1090 may similarly include an operator interface 1092 which may include similar features and capabilities as operator interfaces 1052, 1082 described above. Additionally, or alternatively, the user device 1090 may comprise a controller 1094 that may include the same or similar features, components, and/or characteristics as the controller 1084 of the base station 1080. For example, the user device controller 1084 may calculate drivable path plans, output control signals to control the curvature control system 1060, the speed control system 1046, and/or he implement control system 1048 to direct the autonomous vehicle 1010. The user device 1090, for example, can include an application that allows the user (e.g., a remote operator) to communicate commands to the autonomous vehicle 1010 (e.g., via a transceiver 1096) and/or receive information about the autonomous vehicle 1010. Alternatively, or additionally, the user device 1090, for example, can include an application that allows the user to observe the autonomous vehicle 1010 move through a map of the work area where the autonomous vehicle operates.

The user device 1090, for example, may include an application that can receive the indication associated with the remote operator or which can receive other user or operator inputs. The user device 1090, for example, may include an application that can display any of the information disclosed in this document.

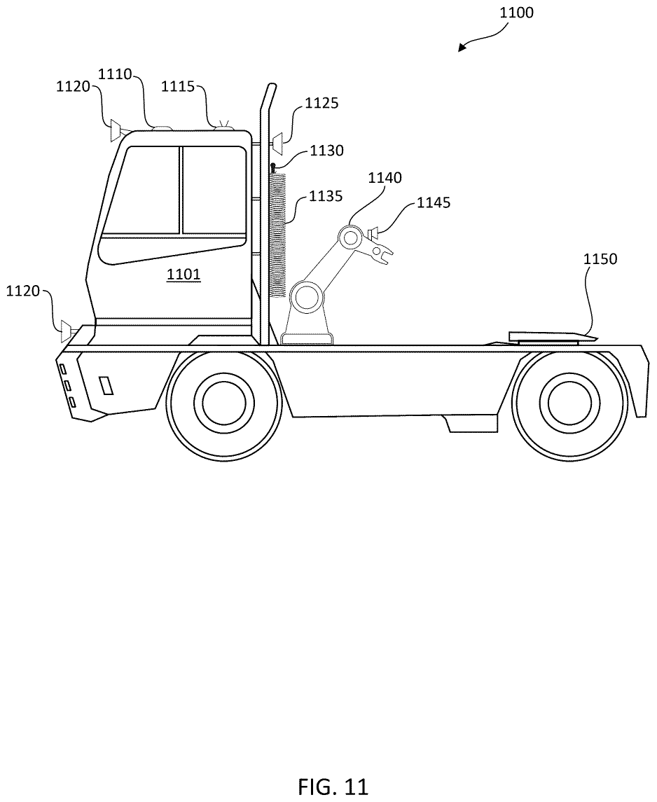

FIG. 11 is a side view of an autonomous yard truck 1100 according to some embodiments. The autonomous yard truck 1100 includes a cab 1101 that may be used to drive the autonomous yard truck 1100 manually. The autonomous yard truck 1100 may include one or more of the components shown in FIG. 10. The autonomous yard truck 1100 may also include a brake system, an engine, a transmission, steering, sensor array, etc. such as, for example, as shown in FIG. 10.

In some embodiments, the autonomous yard truck 1100 may include a sensor array that includes sensors 1120 (e.g., sensor array 1079) disposed at various locations on the autonomous yard truck 1100 such as, for example, on the cab 1101, bumper, housing, frame, etc. The sensors 1120 may include infrared sensors, ultrasonic sensors, magnetic sensors, radar sensors, LiDAR sensors, terahertz sensors, sonar sensors, cameras, etc. The autonomous yard truck 1100 may also include one or more backup sensors 1125 such as, for example, infrared sensors, ultrasonic sensors, magnetic sensors, radar sensors, LiDAR sensors, terahertz sensors, sonar sensors, cameras, etc.

In some embodiments, the autonomous yard truck 1100 may include a spatial locating device (or GPS) antenna 1110. In some embodiments, the autonomous yard truck 1100 may include a transceiver antenna 1115.

In some embodiments, the autonomous yard truck 1100 may include one or more hoses 1135 that can be connected with a trailer such as, for example, two or three hoses. Each hose may have a hose connector 1130 that can be connected with a trailer hose connector. For example, the one or more hoses 1135 of the autonomous yard truck 1100 may include a service brake hose, an emergency brake hose, and/or a refrigerant hose.

In some embodiments, the autonomous yard truck 1100 may include a robotic arm 1140 disposed on the back bed of the autonomous yard truck 1100. The robotic arm 1140 may include any type of robotic arm. The robotic arm 1140, for example, may exert high torque or high pressure sufficient to connect the hose connector 1130 with the trailer hose connector. The hose connector 1130 and/or the trailer hose connector may comprise a glad-hand connector. In some embodiments, when the autonomous yard truck 1100 is not coupled with a trailer, the hose connector 1130 may be positioned in a storage rack at some point on the autonomous yard truck 1100 such as, for example, on the rear of the cab 1101.

In some embodiments, the robotic arm 1140 may include one or more arm sensors 1145 such as, for example, infrared sensors, ultrasonic sensors, magnetic sensors, radar sensors, LiDAR sensors, terahertz sensors, sonar sensors, cameras, etc. The arm sensor 1145, for example, may produce data that can be used to identify the location of a hose connector 1130 and/or a trailer hose connector. The arm sensor 1145, for example, may produce data that can show that a hose connector 1130 and/or a trailer hose connector are sufficiently coupled.

In some embodiments, the autonomous yard truck 1100 may include a fifth-wheel coupling 1150. The fifth-wheel coupling 1150, for example, may be raised or lowered with a fifth-wheel coupling boom. FIG. 11 shows the fifth-wheel coupling 1150 in a lowered position. The fifth-wheel coupling 1150 may couple with a kingpin of a trailer.

When the fifth-wheel coupling 1150 is coupled with a kingpin and the fifth-wheel coupling 1150 is in the raised position, the legs of the trailer may lift off the ground (e.g., automatically). This may allow the autonomous yard truck 1100 to pull the trailer without individually raising the trailer legs.

In some embodiments, the robotic arm 1140 and/or the arm sensor 1145 may be coupled with a thermal management system. A thermal management system may, for example, be coupled with a thermal management system associated with the autonomous yard truck 1100 such as, for example, coupled with the cab heating/cooling system and/or the engine heating/cooling system. A thermal management system may, for example, be an independent system that heats and/or cools the robotic arm 1140 and/or the arm sensor 1145. A thermal management system may, for example, keep the temperature of the robotic arm 1140 and/or the arm sensor 1145 between about 32° F. and about 100° F.

In some embodiments, the autonomous yard truck 1100 may include a deployable shade coupled with the back of the cab 1101. The deployable shade, for example, may be used to screen the sun and/or other lighting from the arm sensor 1145 and/or the one or more backup sensors 1125. The deployable shade, for example, may include an umbrella configuration or an awning configuration. The deployable shade, for example, may be coupled with the roof or an upper portion of the cab.

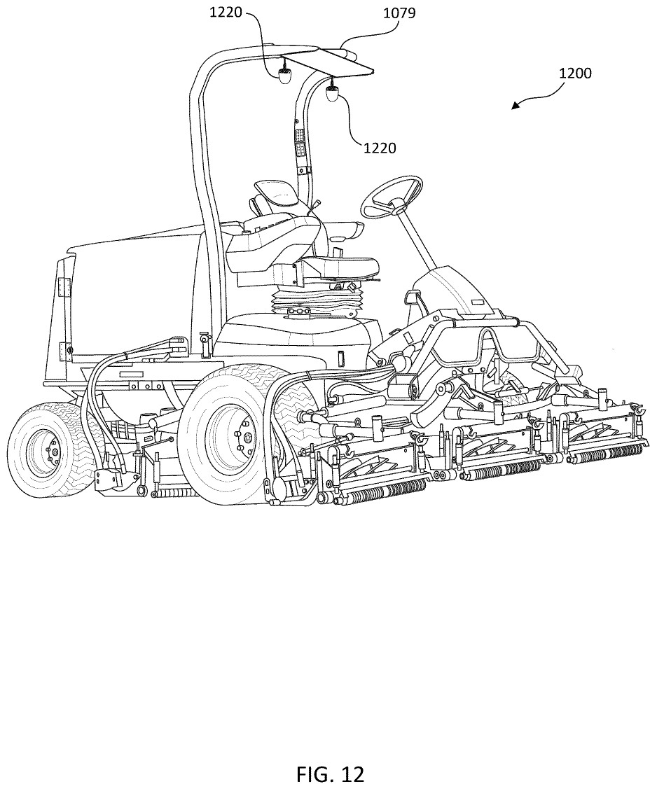

FIG. 12 is a sideview of an example autonomous mower 1200, which may include all or some of the components of autonomous vehicle 1010. The autonomous vehicle in this document may include the autonomous mower 1200. Any type of mower or blades may be used, such as a disc mower. The autonomous mower 1200, for example, may include a sensor array 1079 (or multiple sensor arrays), including sensors 1220. The sensor array 1079 may include, for example, one or more LiDAR, radar, and/or video cameras. The video cameras, for example, may include 360 degree cameras, a front facing camera, and/or a back facing camera.

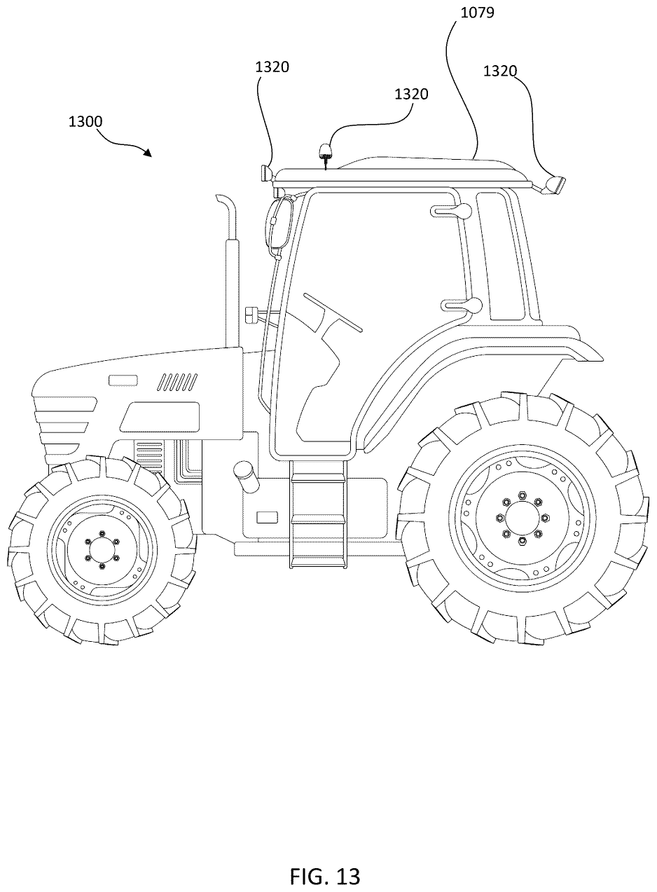

FIG. 13 is a sideview of an example autonomous tractor 1300, which may include all or some of the components of autonomous vehicle 1010. The autonomous vehicle in this document may include the autonomous tractor 1300. In this example, the autonomous tractor 1300 may include standard tractor equipment and/or components. The autonomous tractor 1300 may include or be coupled with any kind of implement such as, for example, a plow, disc plow, reel mower, dumper, lift, bucket, shovel, blade, and/or cutter, etc. The autonomous tractor 1300, for example, may include a sensor array 1079 (or multiple sensor arrays), including sensor(s) 1320. The sensor array 1079 may include, for example, one or more LiDAR, radar, and/or video cameras. The video cameras, for example, may include 360 degree cameras, a front facing camera, and/or a back facing camera.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. An autonomous vehicle comprising:
a steering control system;
a speed control system;
one or more sensors;
one or more processors communicatively coupled with the one or more sensors, the steering control system, and the speed control system; and
one or more computer-readable media having stored thereon instructions that when executed by the one or more processors:
at a first time, receive observed sensor data from a sensor of the one or more sensors showing that a subset of cells of a plurality of cells within an occlusion probability map has been observed, wherein the occlusion probability map represents a sensor field of view within an operating environment;
at a second time, receive occluded sensor data from the sensor of the one or more sensors showing at least the subset of cells of the plurality of cells has not been observed; and
instruct the steering control system and the speed control system to drive the autonomous vehicle along a path through an area in an environment associated with the occluded sensor data when an elapsed time between the first time and the second time is below a time threshold.

2. The autonomous vehicle of claim 1, wherein the observed sensor data shows that the subset of cells of the plurality of cells within the occlusion probability map is non-occluded.

3. The autonomous vehicle of claim 1, wherein the one or more processors further execute instructions that:
set an occlusion probability of the subset of cells within the plurality of cells of the occlusion probability map to a value associated with an observed state based on the observed sensor data; and
after occluded sensor data is received, set the occlusion probability of the subset of cells to a value associated with an Unknown, Occluded, or Likely Occluded state when the elapsed time is equal to or greater than the time threshold.

4. The autonomous vehicle of claim 1, wherein the one or more sensors includes a camera, and the one or more processors further execute instructions that:
send a camera image from the camera and associated with a sensor field of view of the sensor to a remote operator; and
receive an indication associated with the remote operator indicating whether an obstacle is present within the camera image.

5. The autonomous vehicle of claim 4, wherein when the indication from the remote operator indicates presence of an obstacle within the sensor field of view the one or more processors sets an occlusion probability of the subset of cells to a different value.

6. The autonomous vehicle of claim 1, wherein one of the one or more sensors comprises a LiDAR.

7. The autonomous vehicle of claim 1, wherein one of the one or more sensors comprises a depth camera, structured light camera, or a stereo camera.

8. The autonomous vehicle of claim 1, wherein an occlusion probability of the subset of cells of the plurality of cells is initialized to a value corresponding to an Unknown state, an Occluded state, or a Likely Occluded state.

9. A method comprising:
at a first time, receive observed sensor data from a sensor of one or more sensors showing that a subset of cells of a plurality of cells within an occlusion probability map has been observed;
at a second time, receive occluded sensor data from the sensor of the one or more sensors showing at least the subset of cells of the plurality of cells has not been observed; and
instruct a steering control system and a speed control system of an autonomous vehicle to drive the autonomous vehicle along a path through an area in an environment associated with the occluded sensor data when an elapsed time between the first time and the second time is below a time threshold.

10. The method of claim 9, further comprising sending a camera image associated with a sensor field of view of the sensor to a remote operator.

11. The method of claim 10, further comprising receiving an indication associated with the remote operator indicating whether an obstacle is present within the camera image.

12. The method of claim 9, further comprising:
determining whether a cell of the subset of cells is independent when the cell has not been observed;
setting an occlusion probability of the cell to a previous occlusion probability when the cell is not independent; and
setting the occlusion probability using an occlusion probability update function when the cell is independent.

13. The method of claim 9, wherein:
determining whether a cell of the subset of cells is independent when the elapsed time is equal to or greater than the time threshold;
setting an occlusion probability of the cell to a previous occlusion probability when the cell is not independent; and
setting the occlusion probability using an occlusion probability update function when the cell is independent.

14. The method of claim 13, wherein the occlusion probability update function comprises
$${m}_{r , c}^{k} = \frac{{s}_{f} {m}_{r , c}^{k - 1}}{{s}_{f} {m}_{r , c}^{k - 1} + {s}_{r , c} ( 1 - {m}_{r , c}^{k - 1} )}$$
when the subset of cells is observed and
$${m}_{r , c}^{k} = \frac{( 1 - {s}_{f} ) {m}_{r , c}^{k - 1}}{( 1 - {s}_{f} ) {m}_{r , c}^{k - 1} + ( 1 - {s}_{r , c} ) ( 1 - {m}_{r , c}^{k - 1} )}$$
when the subset of cells is not observed, where
$${m}_{r , c}^{k}$$
represents the occlusion probability of map m of the cell at column c and row r for iteration k, s_{r,c} represents a scan cell detection probability of the cell at column c and row r, and s_{f} represents the probability of false detection for the cell at column c and row r.

15. The method of claim 13, wherein the occlusion probability update function comprises a sequence of Bernoulli random variables or a binary Bayes filter.

16. An autonomous vehicle comprising:
a vehicle platform comprising a steering control system and a speed control system;
one or more sensors coupled with the vehicle platform; and
a processor communicatively coupled with the one or more sensors, wherein the processor executes the method according to claim 9.

17. The autonomous vehicle of claim 16, wherein the vehicle platform comprises a steering mechanism in communication with the processor, and the processor communicates steering commands to the steering mechanism based on an occlusion probability of the subset of cells.

18. The autonomous vehicle of claim 16, wherein the vehicle platform comprises a braking mechanism in communication with the processor, and the processor communicates braking commands to the braking mechanism based on an occlusion probability of the subset of cells.

19. The autonomous vehicle of claim 16, wherein one of the one or more sensors comprise a depth camera, structured light camera, or a stereo camera.

20. An autonomous vehicle comprising:
a steering control system;
a speed control system;
one or more sensors;
one or more processors communicatively coupled with the one or more sensors, the steering control system, and the speed control system; and
one or more computer-readable media having stored thereon instructions that when executed by the one or more processors:
at a first time:
receive observed sensor data from a sensor of the one or more sensors showing that a subset of cells of a plurality of cells has been observed, and
instruct the steering control system and the speed control system to drive the autonomous vehicle along a path through an area in environment associated with the observed sensor data;
at a second time when an elapsed time between the first time and the second time is less than a time threshold:
receive first occluded sensor data from the sensor of the one or more sensors showing that the subset of cells has not been observed, and
instruct the steering control system and the speed control system to drive the autonomous vehicle along a path through an area in environment associated with the first occluded sensor data; and
at a third time when an elapsed time between the first time and the third time is equal to or greater than the time threshold:
receive second occluded sensor data from the sensor of the one or more sensors showing that the subset of cells has not been observed, and
instruct the steering control system and the speed control system to stop the autonomous vehicle from driving along a path through an area in environment associated with the second occluded sensor data.
